(19) United States
(12) Patent Application Publication
(10) Pub. No.: US 2003/0027021 A1
(43) Pub. Date: Feb. 6, 2003

(54) Microwave activation of fuel cell gases

(76) Inventors: Viktor Sharivker, Ottawa (CA); Travis Honeycutt, Gainesville, GA (US); Simon Sharivker, Ottawa (CA)

Correspondence Address: Malcolm B. Wittenberg, Dergosits & Noah LLP, Suite 1450, Four Embarcadero Center, San Francisco, CA, 94111, US

(21) Appl. No.: 10/139,020

(22) Filed: May 2, 2002

Related U.S. Application Data
(60) Provisional application No. 60/288,523, filed on May 3, 2001.

(51) Int. Cl. H01M 8/00

(52) U.S. Cl. 429/13

(57) ABSTRACT

A method of increasing the efficiency of a fuel cell having an anode electrode for receiving a reducing agent, cathode electrode for receiving an oxidizing agent, and a proton-conducting membrane separating the anode and cathode electrodes. The method includes exposing at least one of the reducing agent or oxidizing agent to a microwave generator for applying microwave energy thereto.

### RELATED APPLICATIONS

The present application claims priority of Provisional U.S. Application Serial No. 60/288,523, filed on May 3, 2001.

### TECHNICAL FIELD OF INVENTION

The present invention is directed to a method of increasing the efficiency of a fuel cell. Typically, such cells are provided with an anode electrode for receiving a reducing agent, a cathode electrode for receiving an oxidizing agent, and a ion-conducting electrolyte separating the anode and cathode electrodes. Specifically, the present invention is directed to the use of a microwave generator for applying microwave energy to at least one of the reducing agent or oxidizing agent.

### BACKGROUND OF THE INVENTION

Fuel cells are promising and efficient devices capable of directly converting chemical energy into electricity. Such cells are based on a chemical reaction between a reducing agent and an oxidizing agent. Most commonly, the reducing agent is hydrogen and the oxidizing agent is oxygen. In operation, a hydrogen-rich feed stream is provided to the anode side of the fuel cell while the cathode side of the fuel cell is provided with an oxygen-containing stream, typically air, for production of electricity within the fuel cell. Water is the by-product in the generation of electric power. Because of the abundance of hydrogen and oxygen and the innocuous nature of the effluent, the generation of electric power by this means is most attractive.

There are a number of various types of fuel cells which have been investigated by those promoting this technology. For example, solid polymer fuel cells (SPFC), also called polymer electrolyte membrane or proton exchange membrane (PEM) cells are shown schematically in FIG. 1. Specifically, fuel cell 10 is shown being composed of electrode catalyst region 1 having an electrode backing material 2. Hydrogen gas is introduced to anode region 3 where hydrogen produces protons according to the reaction:

H₂=2H⁺+2e⁻

Protons created from the hydrogen source are transferred through a proton-conducting membrane 5 to cathode 4. Typically, at the cathode, the protons react with oxygen providing water as the reaction product according to the following reaction:

½O₂+2H⁺+2e⁻=H₂O

Typically, oxygen gas migrates through porous carbon backing 2 adjacent to cathode 4 and is evaporated through the porous carbon backing 2 as water vapor.

In addition to solid polymer fuel cells, solid oxide fuel cells (SOFC) have been widely used and show great promise in achieving the hoped-for realization of the employment of fuel cells as viable sources of clean and efficient power.

The operation of such a device is based on oxide ions passing from the cathode which is the region of the oxygen electrode to the anode, or region of the fuel electrode where they combine with hydrogen to form water. The overall electrode reactions are:

Cathode:

O₂+2e⁻=O⁻²

Anode:

O⁻²+H₂=H₂O+2e⁻

The maximum electrical work that can be derived from such a fuel cell (operating at isothermal conditions) is provided by the change in Gibbs energy (ΔG) according to the following equation:

W_{E,rev}=−ΔG=nFEᵣₑᵥ

wherein W_{E,rev} is the work from the converter when the process is carried out reversibly.

E ᵣₑᵥ is the reversible potential of the cell,

n is the number of electrons involved in the electrochemical process, and

F is the Faraday constant.

Not surprisingly, experimental data has shown that not all of this energy is converted into electrical energy, even when very small currents are drawn from the cell. The ohmic losses inherent in such a cell are substantial. In addition, the overpotential, mainly found at the cathode, reduces cell voltage. Even when platinum is employed as a catalyst, the reversible potential of the cell is not obtainable. It was determined that for solid polymer fuel cells, the open circuit potential is approximately one volt which is 0.2 volts lower than that of the reversible cell potential calculated theoretically.

Fuel cell efficiency is directly proportional to the cell voltage and power density. The reduction of the cell potential followed by increasing the cell current density results in reduction of fuel cell efficiency and power density, which is a product of voltage and current density. Higher achievable power density directly translates to smaller, thus less expensive, fuel cells. It was, thus, a design goal of the present invention to achieve higher power density which directly translates into smaller, thus less expensive, fuel cells. It was further an object of this invention to minimize energy losses and thus create a commercially competitive fuel cell operating as a power plant.

As will be more readily appreciated in considering the following disclosure, applicant has achieved certain design parameters by employing microwave energy to increase power density and minimize energy losses. Applicant's own U.S. Pat. No. 6,184,427 teaches a process and apparatus for microwave cracking of plastic materials. The disclosure of the '427 patent, which is incorporated by reference herein teaches the use of microwave irradiation for the catalytic conversion of high molecular weight organic materials in order to produce light hydrocarbon molecules. The electromagnetic energy made available by microwave sources is enhanced by employing pulverized electrically conducting material used as sensitizers. These sensitizers are composed of solid materials with moderate electrical conductivity which are employed to transfer energy to the organic molecules made available from plastic sources. The conducting electrons in the sensitizers are accelerated in the oscillating electric field and dissipate their kinetic energy as heat. Various sensitizers, as well as catalysts used in conjunction herewith, are disclosed in the cited '427 patent, again, the disclosure of which is incorporated herein by reference.

The same fuel sources, sensitizers, and catalysts can be employed in practicing the present invention as will be more thoroughly described hereinafter. As related technology, reference is made to S. Kjelstrup, P. J. S. Vie, and D. Bedeaux, “Irreversible Thermodynamics of Membrane Surface Transport with Application to Polymer Fuel Cells,” found in Surface Chemistry and Electrochemistry of Membranes, edited by T. S. Sorensen; Marcel Dekker, New York, pp. 483-510, 1999, which discloses the use of porous carbon while V. N. Parmon, G. G. Kuvshinov, V. A. Sadykov, and V. A. Sobyanin, “New Catalysts and Catalytic Processes to Produce Hydrogen and Syngas from Natural Gas and Other Light Hydrocarbons,” found in Studies in Surface Science and Catalysis, vol. 119, pp. 672-684, 1998, and S. K. Ratkje and S. Moller-Holst, “Energy Efficiency and Local Heat Production in Solid Oxide Fuel Cells,” found in Electrochimica Acta, vol. 38, nos. 2-3, pp. 447-453, 1993, teach the use of cermet as electrode material for fuel cells. According to cited '427 patent, both carbon and cermet can be used in an electromagnetic field to create micro-discharges proximate a sensitizer surface when the sensitizers are subjected to microwave irradiation. The microwave discharges represent highly non-equilibrium systems of ionized molecules and electrons where the kinetic energy (temperature) of electrons is significantly higher than the average temperature of the subject system. This electron energy is efficient to break chemical bonds in the molecules forming excited species in the electrode gases, such as atoms and radicals. For example, A. Oumghar, J. C. Legrand, A. M Diamy, N. Turillon, and R. I. Ben-Aim in the article entitled, “A Kinetic Study of Methane Conversion by a Dinitrogen Microwave Plasma,” found in Plasma Chemistry and Plasma Processing, vol. 14, no. 13, pp. 229-249, 1994, show generating active species by microwave discharge employing a mixture of methane and nitrogen while E. Ekinci in his article entitled, “Atomic Hydrogen Production and Modelling Revisited,” found in Hydrogen Energy System: Production and Utilization of Hydrogen and Future Aspects, NATO ASI SER., SER. E, No. 295, pp. 111-133, 1995, has made a similar disclosure employing methane and oxygen.

Microwave energy has been employed by others in conjunction with hydrocarbon sources to reform such sources in a number of meaningful ways. For example, it has been demonstrated that methane (natural gas) can be converted directly to hydrogen which includes the formation of active species, including hydrogen atoms, ions and free radicals.

For example, A. Oumghar, J. C. Legrand, A. M. Diamy, and N. Turillon, “A Kinetic Study of Methane Conversion by an Air Microwave Plasma,” found in Plasma Chemistry and Plasma Processing, vol. 15, no. 1, pp. 87-107, 1995, and A. D. MacDonald, “Microwave Breakdown in Gases,” John Wiley & Sons, have taught the use of microwaves to break down gases in gaseous mixtures such as oxygen and air. M. I. Ioffe, S. D. Pollington, and J. K. S. Wan, “High-Power Pulsed Radio-Frequency and Microwave Catalytic Processes: Selective Production of Acetylene from the Reaction of Methane Over Carbon,” found in Journal of Catalysis, vol. 151, pp. 349-355, 1995, has taught the use of microwaves in treating methane and hydrogen. J. Huang, M. V. Bandi, S. L. Suib, J. B. Harrison, and M. Kablauoi, “Partial Oxidation of Methane to Methanol through Microwave Plasmas. Reactor Design to Control Free-Radical Reactions,” found in Journal of Physical Chemistry, vol. 98, no. 1, pp. 206-210, 1994, has taught the use of microwaves and their impact upon methane and oxygen. Use of microwaves in conjunction with methane and steam was disclosed by D. O. Cooney and Z. Xi, “Production of Hydrogen from Methane and Methane/Steam in a Microwave Irradiated Char-Loaded Reactor,” found in Fuel Science and Technology International, vol. 14, no. 8, pp. 1111-1141, 1996, while K. Tanaka, J. Okabe, and K. Aomura, “A Stoicheiometric Conversion of CO₂+CH₄ into 2 CO+2H₂ by Microwave Discharge,” found in Journal of Chemistry Society, Chem. Commun., pp. 921-922, 1982, has taught employing microwaves to treat methane and carbon dioxide. Microwave energy has been employed by others in conjunction with hydrocarbon sources to reform such sources in a number of meaningful ways. For example, it has been demonstrated that methane (natural gas) can be converted directly to hydrogen which includes the formation of active species, including hydrogen atoms, ions and free radicals.

It is thus an object of the present invention to impact certain feed gases in order to improve performance characteristics and ultimately the utility of fuel cells through the use of microwave energy.

This and further objects will be more readily apparent when considering the following disclosure and dependent claims.

### SUMMARY OF THE INVENTION

The present invention is directed to a method of increasing the efficiency of a fuel cell having an anode electrode for receiving a reducing agent, a cathode electrode for receiving an oxidizing agent, an ion-conducting membrane or solid electrolyte separating the anode and cathode electrodes, and a microwave generator for applying microwave energy to at least one of the reducing or oxidizing agents.

### BRIEF DESCRIPTION OF THE FIGURES

FIG. 1 is a schematic illustration of a typical fuel cell of the prior art.

FIG. 2 is a schematic illustration of the present invention.

FIG. 3 is a schematic illustration of a microwave activator useful in a solid polymer fuel cell.

FIG. 4 shows a schematic illustration of a microwave activator for use in a solid oxide fuel cell.

### DETAILED DESCRIPTION OF THE INVENTION

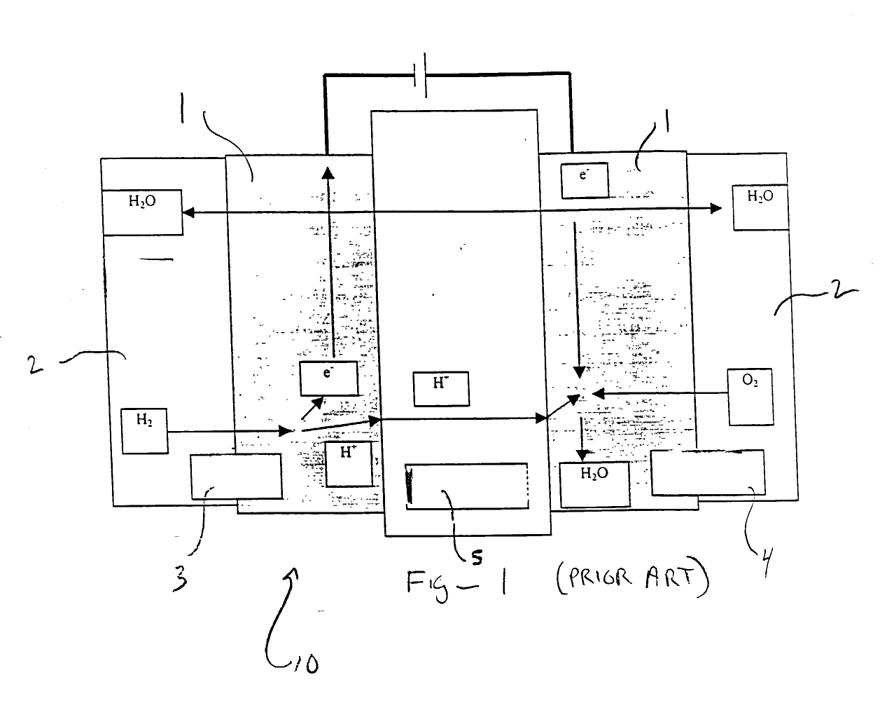

As was noted previously, the present invention is directed to the use of microwave energy to act upon electrode materials in a fuel cell. As noted with regard to the previous discussion of FIG. 1, fuel cells include an anode compartment for receiving a reducing agent such as hydrogen and a cathode compartment which receives an oxidizing agent such as oxygen and which combine to generate electrical power yielding water as a by-product. Microwave energy and its effect upon the reducing and oxidizing agents can be made either inside or outside of these various electrode compartments.

The ideal electrode material for fuel cell use in practicing the present invention is porous carbon which, according to the above-referenced U.S. Pat. No. 6,184,427, is also suitable for use as a sensitizer to generator micro-discharges under the influence of microwave irradiation and to thus enhance the creation of excited species. Microwave irradiation of electrode gases provides the ability to create conditions for production of activated species in the cathode and anode compartments, such as oxygen and hydrogen ions, atoms and free radicals. By doing so, overpotentials are decreased noting that the energy which is required to discharge excited species at the cathode and anode is significantly less than the energy required for discharge of the molecular oxygen and hydrogen species at the electrodes.

In addition to the above, the use of microwave pre-activation of the electrode gases eliminates the dependence upon platinum catalysts which is generally believed to be necessary in the anode and/or cathode regions of the fuel cell.

Further, by practicing the present invention, solid polymer fuel cells may be run on fuel sources, such as natural gas, which are less costly than hydrogen. Specifically, it is known that the initiation of methane decomposition requires the employment of energy high enough to break the H—CH₃ bond. For fuel cell use, this created active species must have a long enough transition life to be present when the methane is introduced into the fuel cell. In summary, microwave energy is capable of providing a fuel cell reducing agent employing methane as the feed gas. Further, atomic hydrogen can also be generated from molecular hydrogen which is present as a result of methane decomposition as H—CH₃ bond energies have similar values. The study of electron-methane collisions points out that electrically excited methane is the precursor for the formation of hydrogen according to the following reactions:

CH₄→CH₃+H

CH₄→CH₂+H+H

CH₄→CH₂+H₂

CH₄→CH+H₂+H

CH₄→C+H₂+H₂

H₂→2H→2H⁺+e⁻

It is believed that conditions exist through judicious application of microwave energy, together with sensitizers and/or catalysts, where substantially complete conversion of methane and/or other hydrocarbons to hydrogen is achievable.

Similarly, microwaves can be used to irradiate a gas mixture such as CH₄/O₂ whereby active oxygen species can be created. For example, oxygen atoms can be produced in the ground state (³P) and metastable states (¹D) and (¹S). In doing so, ions O⁻ and O₂ are formed as well as long living active radicals when air is subjected to microwave irradiation. Oxygen atoms are disassociated and, assuming the existence of an unstable intermediate state, excess energy is divided between the atoms in the form of kinetic energy. The following reaction describes such radical creation:

O₂→(O₂)_{unstable}→O⁻+O+K.E.

In practicing the present invention using methane as a fuel source, concentrations of ions are developed in the range of about 10¹¹ or 10¹² molecules/ml. In subjecting the combination of methane and oxygen to microwave energy, it was noted, through gas chromatography, the existence of syngas (CO/H₂). Further, the combination of carbon dioxide and methane (CO₂/CH₄) can be employed as a source of hydrogen for the anode side of the cell through the following reaction:

CO₂+CH₄→2CO+2H₂

As noted from the above discussion, there are a number of various hydrocarbon sources which can be employed in carrying out the successful generation of electricity through the use of fuel cells when microwave energy is employed as suggested. This can be important economically for methane is produced from the decomposition of certain organic materials; as such, it can be a more economic fuel source than hydrogen gas. When porous carbon is employed as the electrode of a fuel cell, it can also perform the function of a sensitizer to enhance microwave activation of the electrode gases. Even on the cathode side of the cell, microwave energy can be useful for it would enable the effective use of air to provide the oxidizing agent, which will decrease activation over-potential.

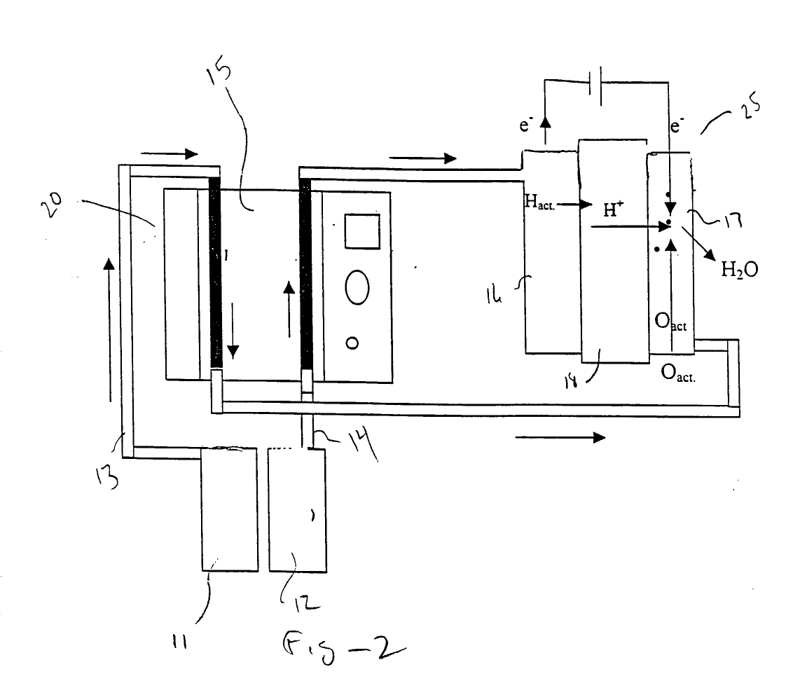

FIG. 2 illustrates, schematically, the present invention. Specifically, pursuant to the present invention, microwave reactor 20 is provided whereby an oxidant, such as oxygen, from air and/or other oxidizing agent, is provided from canister 11 while the reducing agent, such as hydrogen or methane, is provided from canister 12 which is caused to pass through the electromagnetic field. In this instance, the oxidizing and reducing gases are subjected to microwave energy prior to their introduction into fuel cell 25 having anode 16 and cathode 17 or during their introduction in the fuel cell. The oxidizing gas is passed through channel 13 while reducing gas passes through channel 14, again, in both instances, the gases benefiting by exposure to microwave radiation. FIG. 2 further shows the migration of protons across proton-conducting membrane 18 creating electricity through the migration of electrons as shown with water being the eventual by-product.

Suitable sensitizers and catalysts can be employed in practicing the process of FIG. 2. Suitable sensitizers and catalysts are disclosed in applicant's previously issued U.S. Pat. No. 6,184,427, the disclosure of which is incorporated by reference for the identification of such materials. Quartz tubes or other suitable configurations used in the presently proposed microwave reactor are packed with suitable sensitizers and/or catalysts to create conditions for the generation of micro-discharges near the surface of the sensitizer when the reactive gases are irradiated with microwave energy. As noted, the microwave discharges represent a highly non-equilibrium system of ionized molecules and electrons with a kinetic energy, measured in terms of electron temperature, significantly higher than the average kinetic energy or temperature of the overall system. The electron energy is sufficient to break chemical bonds in the molecules, forming excited species of atoms and radicals in the electrode gases. This facilitates charge transfer during the oxidation and reduction reactions. As a result, the activation overpotentials during fuel cell polarization will be significantly decreased. For example, when the present invention is employed, the following represents a typical series of reactions induced by microwave energy when hydrogen and methane are used as feed gases:

$$\begin{matrix}{H}_{2} & {\to }^{ M W } & 2 H \\ {CH}_{4} & \to & {CH}_{3} + H \\ {CH}_{3} & \to & {CH}_{2} + H \\ {CH}_{2} & \to & CH + H \\ CH & \to & C + H \\ H & \to & {H}^{+} + e\end{matrix}$$

Similarly, when oxygen is used as the feed gas, the following reactions occur:

$${O}_{2} \qquad {\to }^{ M W } \qquad 2 O$$

$$O + {2}^{e -} = {O}^{- 2}$$

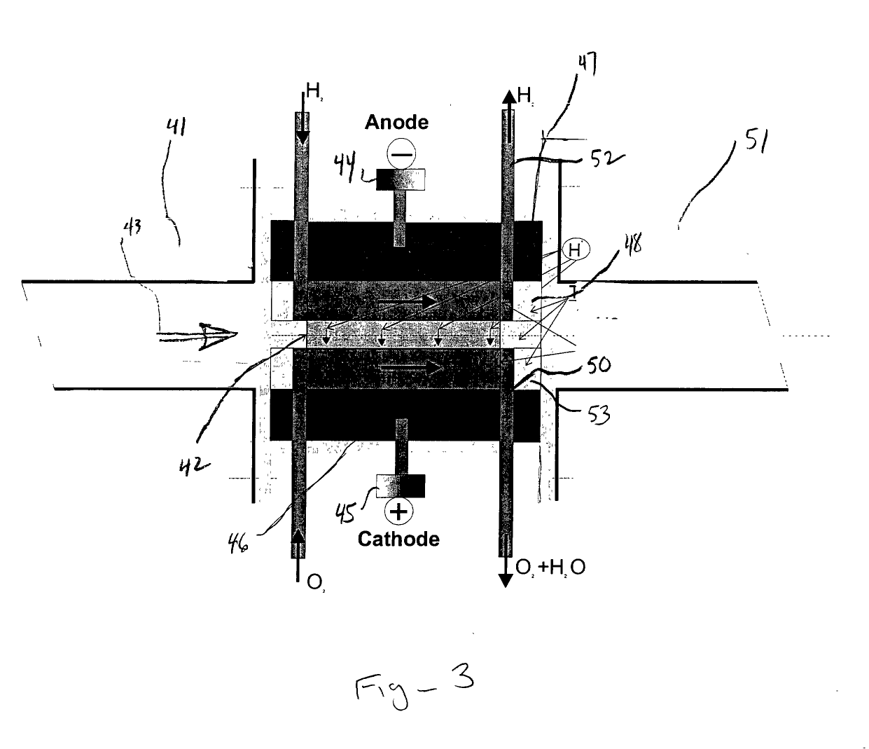

FIG. 3 illustrates a microwave activator useful in a solid polymer fuel cell (PEM) environment. Here, the fuel cell is placed into a Teflon insert, which is located within cutoff tube 41/51. The horizontal axis of the fuel cell is perpendicular to the direction of microwave propagation shown as arrow 43 and thus perpendicular to the induced electrical field. High density graphite layers 46 and 47 are applied to sandwich the proton exchange membrane 42 and to support anode 44 and cathode 45, as shown. Porous carbon layers acting as gas diffusers are provided as elements 50 and 52, which are encased within Teflon masks 48 and 53. It is noted that the Teflon block serves a dual function. Specifically, it acts as a structural (physical) support for the fuel cell components in the microwave cavity and, at the same time, is transparent to electromagnetic waves. As further noted by the structural configuration of FIG. 3, components of the fuel cell of which exposure to an electromagnetic field is not desirable, such as current collectors and wires, can be placed in the internal volume of the cutoff tube, which as noted by reference to FIG. 3, is located out of the microwave wave guide, recognizing that microwave energy is not propagated there. The porous carbon gas diffusion backing elements 46 and 47 are located within the wave guide and serve as a source of sensitizer material.

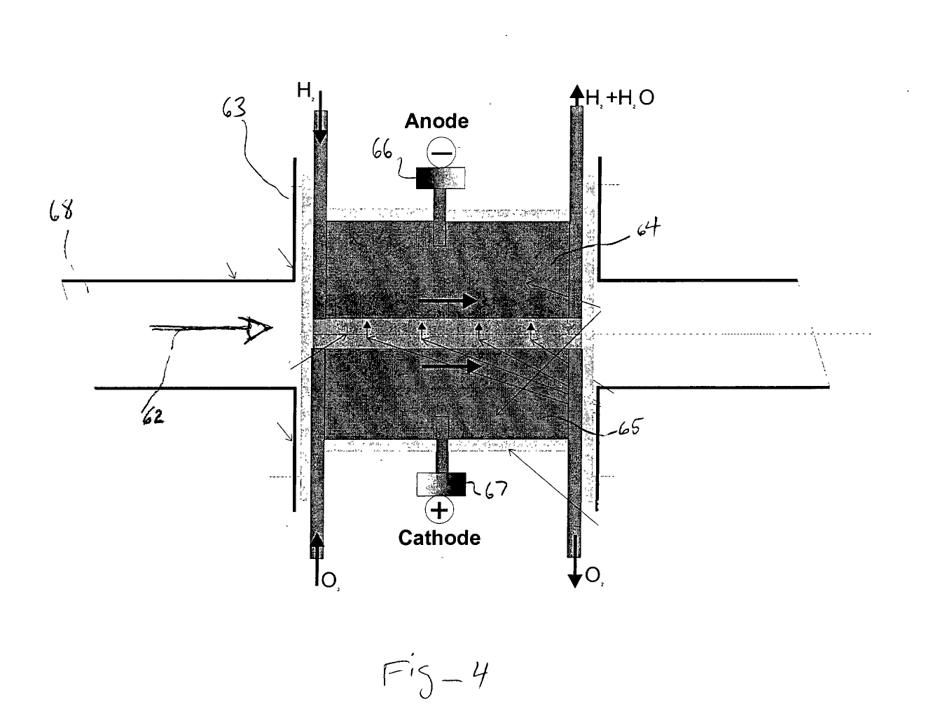

FIG. 4 illustrates the application of the present invention in a solid oxide fuel cell. In this instance, hydrogen and oxygen are converted to water generating electricity at a temperature of approximately 1000° C. The main losses in energy efficiency are due to overpotentials and incomplete electrode reactions. Ohmic resistance of the electrolyte plays a minor role in this type of fuel cell. It is noted that hydrogen can be produced outside or inside of the cell before conversion. Generally, oxygen is supplied from air. Microwave activation, which is propagated in the direction of arrow 62 within waveguide 68, activates the hydrogen and oxygen sources to create activated (both neutral and metastable) species in the electrode compartments in the form of oxygen and hydrogen atoms, ions and radicals. Charge transfer is made through solid electrolyte 61, noting that through the practice of the present invention, increased charge transfer and decreased activation potentials are achieved. Performance of the fuel cell is improved due to increasing energy efficiency and power density. The fuel cell of FIG. 4 employs porous collector blocks made of, for example, cermet 64 and 65, supporting anode 66 and cathode 67.

As noted previously, in order to enhance complete electrode reactions, concentration overpotential must be reduced. Pursuant to the present invention, this can be achieved by the partial ionization of the oxidizing agent, such as oxygen, by creating a plasma from air as a result of the introduction of microwave energy to the cathode material. If air is employed, charged species, such as oxygen ions, are created in the cathode gas which in turn establishes a concentration gradient to facilitate ionic transport through the solid electrolyte 61 which is an oxygen conducting ceramic. This results in a decrease in the concentration overpotential. A partial ionization rate is established to provide the cathode with electronic acceptors in the form of molecular oxygen and atoms. Ion concentrations in the created air plasma are about 10¹¹ to 10¹² molecule/ml, minimizing their impact of the concentration of electron acceptors.

It is noted that there are two basic methods of using microwave-induced discharge for the activation of electrode gases in fuel cells. The first such embodiment is shown in FIG. 4 wherein the active region of discharge is within the electrode compartment of the fuel cell whereby the electrode material is used as the sensitizer or catalyst for microwave activation. All of the gaseous components pass through the active discharge zone in the electrode compartment whereby conditions of activation are determined by the composition of gas and electrode material. The products of the gas phase reactions, including the excited particles and molecules, will be discharged electrically on the fuel cell electrodes. Foreign bodies are placed in the active microwave discharge region resulting in selective heating of the electrode materials. In FIG. 4, this is composed of cermet. Activated species are created by microwave irradiation and high thermal energy will not be required in this case for the electrochemical process. As a consequence, solid oxide fuel cells can be operated at temperatures lower than conventionally thought possible.

In the second method of fuel cell operation, the active microwave discharge region and electrode compartments are physically separated. Electrode gases pass through the microwave discharge producing active particles which then travel to the reaction chamber where they discharge electrically at the electrodes of the fuel cell. Activated gases contain stored energy, which is present as excited species. In this embodiment, conditions must be established, noting the lifetimes of charged and excited species. Specifically, the distance (d) from discharge is a variable to consider for the active species to participate in electrical/chemical processes. For experiments conducted in working with the present invention using methane, this distance was between 0 (epicenter of the discharge) and 3 ms where d=3.2 cm. With this in mind, there are actually three different zones within the system:

1) d=0-2 cm where all the chemically active species plus energetic electrons were present; the electron temperature was of the order of 10⁴K;

2) d=2-3 cm where intermediate distances correspond to the beginning of post-discharge; energetic electrons have disappeared;

3) d>3 cm where there was attenuated post-discharge in which the active species remaining were those having long lifetimes.

Initiation of methane decomposition requires species with energy high enough to break the H—CH₃ bond and create activated species for introduction within the fuel cell. Clearly, microwave irradiation is capable of performing this function. As noted previously, atomic hydrogen can also be generated from molecular hydrogen which is present in the gas phase as a result of methane decomposition as H—H and H—CH₃ bond energies have similar values. Clearly, conditions can be established where the microwave irradiation of hydrogen and methane will create sources of activated proton species at conversion levels of virtually 100 percent at the anode.

### EXAMPLES

### Example 1

A first test was conducted to verify cathode gas ionization as a result of microwave irradiation. A single cell was constructed including a microwave chamber made from WR975 waveguide, two copper electrodes with carbon sensitizers, and plastic spacers located between electrodes. The spacers were sized to create a gap between electrodes of 1 cm. Oxygen was supplied from an air source, naturally containing approximately 20 mol % O₂ and 80 mol % N₂. Gas flow was maintained a constant 2 l/min. A microwave generator operating at 915 MHz was employed with the WR975 waveguide together with a circulator and stub tuners used to supply and attenuate the microwave energy in the reaction chamber between electrodes. Microwave power was applied in the range of from 0 to 800 W and resistance between electrodes was decreased from 8 at 0 power to 10⁴-10⁶ Ohm at 10-800 W.

### Example 2

Next, a test was conducted to verify anode gas ionization as a result of microwave irradiation. As in the previous example, a single cell assembly was fabricated including a microwave chamber again made from a WR975 waveguide. Two copper electrodes were employed with carbon sensitizers and plastic spacers used between electrodes to create a gap of 1 cm. Hydrogen gas was supplied into the space between electrodes at a flow of up to 2 l/min. A microwave generator operating at 915 MHz within the WR975 waveguides was employed together with a circulator and stub tuners to supply and attenuate the microwave energy in the reaction chamber between electrodes. The microwave power was applied in the range of from 0 to 800 W, again, noting the resistance between electrodes being decreased from 8 at 0 power to 10⁴-10⁶ Ohm at 10-800 W.

### Example 3

As previously noted, prior fuel cells traditionally employ a platinum catalyst. This example was carried out to confirm the viability of a fuel cell while eliminating the costly platinum catalyst within the system. A cell was produced including a microwave chamber made from WR975 waveguide, two copper electrodes with carbon sensitizers and plastic spacers located between electrodes. In addition, a Nafion membrane was located between the plastic spacers. This produced a gap between electrodes and membrane of 0.5 cm. Pure hydrogen gas and air, saturated with water were used. Gas flow was maintained constant at levels up to 2 l/min corresponding to gas utilization at high current density. System pressures were kept in the range of from 1 to 4 bar at both electrodes. Safety precautions were taken by flushing the system with nitrogen gas for ten minutes before and after each test. A microwave generator was employed operating at 915 MHz employing the above-noted WR975 waveguides, circulator and stub tuners to supply and attenuate the microwave energy in the reaction chamber between electrodes. The microwave generator was operated at 10 W power. Open circuit potential (OCP) for the cell operating under microwave irradiation was measured and the results tabulated in Table 1 as follows:

| | Cell with microwave | Cell with commercial |
|---|---|---|
| | activation (present | electrode, |
| | invention) V | V |
| OCP at 70° C. | 1.186 | 0.989 |
| OCP at 50° C. | 1.188 | 0.984 |
| OCP at 30° C. | 1.185 | 0.991 |

Polarization characteristics for the cell tested under microwave irradiation are shown at Table 2:

| Cell Potential | Cell Current Density | Overpotentials | Power Density |
|---|---|---|---|
| V | A/cm² | V | W/cm² |
| 1.186 | 0 | 0 | 0 |
| 0.90 | 1.7 | 0.286 | 1.53 |

OCP and polarization characteristics for the single cell containing commercial electrodes with platinum (0.5 mg Pt/cm²) in Nafion membrane are shown for comparison in Tables 1 and 3, respectively:

| Cell Potential | Cell Current Density | Overpotentials | Power Density |
|---|---|---|---|
| V | A/cm² | V | W/cm² |
| 0.989 | 0 | 0 | 0 |
| 0.60 | 1.7 | 0.389 | 1.03 |

It is concluded from the comparison of data contained in Tables 2 and 3 that cells with microwave activation and without platinum catalysts performed better than cells with state of the art electrodes.

1. A method of increasing the efficiency of a fuel cell having an anode electrode for receiving a reducing agent, a cathode electrode for receiving an oxidizing agent, a proton-conducting membrane or other solid electrolyte with hydrogen conductivity or oxygen conducting solid electrolyte separating said anode and cathode electrodes and a microwave generator for applying microwave energy to at least one of said reducing agent or oxidizing agent.

2. The method of claim 1 wherein at least one of said anode or cathode electrodes are composed of porous carbon.

3. The method of claim 1 wherein said reducing agent comprises a gas which includes hydrogen.

4. The method of claim 1 wherein said oxidizing agent comprises a gas that includes oxygen.

5. The method of claim 1 wherein at least one of said reducing agent or oxidizing agent is in contact with a sensitizer during exposure to microwave energy.

6. The method of claim 1 wherein at least one of said reducing agent or oxidizing agent is brought into contact with a catalyst during exposure to microwave energy.

7. The method of claim 1 wherein said reducing agent is exposed to microwave energy prior to its introduction to said anode electrode.

8. The method of claim 1 wherein said oxidizing agent is exposed to microwave energy prior to its introduction to said cathode electrode.

9. The method of claim 1 wherein said reducing agent comprises a gas produced from exposure of a hydrocarbon fuel to microwave energy.

10. The method of claim 1 wherein said reducing agent comprises hydrogen and carbon monoxide.

11. The method of claim 9 wherein said hydrocarbon fuel comprises methane.

12. The method of claim 1 wherein said fuel cell is located within a Teflon insert.

13. The method of claim 1 wherein said fuel cell includes a porous electrode comprised of cermet or metal.

14. The method of claim 1 wherein said microwave energy is applied to at least one of said reducing agent or oxidizing agent within said fuel cell.

15. The method of claim 1 wherein said microwave energy is applied to at least one of said reducing agent or oxidizing agent prior to the introduction of said reducing agent or oxidizing agent to said fuel cell.

16. The method of claim 1 wherein either the reducing or oxidizing agents are subjected to microwave energy inside of the fuel cell.

17. The method of claim 1 wherein both the reducing and oxidizing agents are subjected to microwave energy inside of the fuel cell.
